(19) United States
(12) Patent Application Publication
(10) Pub. No.: US 2020/0085538 A1
(43) Pub. Date: Mar. 19, 2020

(54) MAXILLARY TEETH ORTHODONTIC DEVICE

(71) Applicant: Joong Han KIM, Seoul (KR)

(72) Inventor: Joong Han KIM, Seoul (KR)

(21) Appl. No.: 16/471,758

(22) PCT Filed: Dec. 19, 2017
(86) PCT No.: PCT/KR2017/014989

§ 371 Date: Jun. 20, 2019

(30) Foreign Application Priority Data
Dec. 21, 2016 (KR) 10-2016-0175715

(51) Int. Cl. A61C 7/10

(52) U.S. Cl. CPC A61C 7/10

(57) ABSTRACT

The present invention relates to a maxillary teeth orthodontic device capable of correcting upper jaw molars and anterior teeth by moving the upper jaw molars and the anterior teeth in forward and backward directions. The maxillary teeth orthodontic device comprises: a body attached to the bottom surface of the gums of the upper jaw; a connection leg of which one end is connected and extended from the body; a molar fixing part connected to the other end of the connection leg and fitted into a molar; and a ring part connected to one side of the lower surface of the body, wherein the body is divided into a first body and a second body such that gaps are adjusted by allowing the first body and the second body to be spaced from each other or approach each other in the incisor direction and the airway direction of the upper jaw.

### BACKGROUND

Generally, in order to extend left and right sides of the upper jaw, which is relatively small and narrow in a protruding lower jaw that is, lantern jaw, and correct or rearrange teeth, an orthodontic device is installed in the oral cavity.

As such, in the orthodontic device typically and mainly used in the prior art, two facing bases (bodies) are operated to have a space therebetween, and front teeth are widened in both side directions of the cheek with reference to the forward direction so as to widen the palate, nasal septum and nasal cavity, thereby correcting the lantern jaw or the set of teeth.

However, the above method could not implement tooth movement to create a space in a narrow dental arch of a patient or close a gap in a dental arch having many gaps. Further, in the case of a jaw having buck teeth, it is not possible to create a space by moving the entire maxillary teeth set in the incisor direction or the airway direction. Accordingly, in order to create a space during correction, an orthodontic procedure involving tooth extraction (pulling out a tooth) is often executed and this is accompanied with pain or considerably extends a period of time for tooth movement, therefore, inevitably entailing limitation such as inconvenience and inefficiency.

In related technologies, Korean Patent Registration No. 10-0479967 discloses an orthodontic member (prior art 1).

The prior art 1 relates to “an orthodontic member for effectively correcting a tooth extraction space and treating teeth, being provided with a pre-designed hook to prevent excessive slanting of teeth when closing an extraction space during lingual orthodontics and to apply force depending upon types of teeth to be corrected, thereby achieving desired tooth movement.”

Another technique disclosed in Korean Patent Registration No. 10-1205632 relates to a labial and lingual orthodontic device for lantern jaw (prior art 2).

The prior art 2 described “an object of developing an orthodontic device capable of safely moving tooth roots as well as a tooth head of a protruding alveolar bone in the backward direction so as to provide good physiognomy and a healthy set of teeth.”

However, the prior art 1 and 2 are considered to be partially different from the orthodontic device proposed by the present applicant in terms of operating mechanism and effects achieved by the same.

Meanwhile, technologies partially relevant to the invention proposed by the present applicant may include, for example, a maxillary dental arch width correction device (prior art 3) disclosed in Korean Patent Registration No. 10-1111976.

The prior art 3 relates to “a maxillary dental arch width correction device, comprising: a width correction body unit which generates a force to correct a width in the maxillary dental arch; and a pushing unit which is provided in the width correction body unit and applies an extending force to the maxillary bone while being widened in both left and right directions by the width correction body unit in order to extend the maxillary dental arch to both sides.”

Another technique disclosed in Korean Patent Registration No. 10-1466158 relates to a three-dimensional tooth movement structure in the maxillary molar area (prior art 4).

The prior art 4 described that “a palatal surface extending member having a pair of left and right divided bodies which are placed at both palatal surfaces to the upper jawbone as the center in order to correct widths of left and right maxillary dental arches; a pair of support wires wherein one end of each support wire is fixed to the extending member; a pair of left and right wire rails wherein one end of each wire rail is fixed to each of the divided bodies and the other end is located along both dental arches and fixed to the other end of each support wire; a band fixed to any one molar in the dental arches while surrounding the molar; a molar traction unit which includes a connection wire having a bent end fixed to one side of the band and a sliding tube coupled at the other end of the connection wire to perform sliding movement while surrounding the rails; and an elastic rubber, both ends of which are engaged in a ring formed at an end of the wire rail and a ring groove bent-formed at one side of the connection wire in the molar traction unit, respectively, thereby gaining a pulling force from an elastic restoring force of the elastic rubber, are included.”

However, the above prior art 3 and 4 are also configured to perform correction in a lateral direction and still entail limitation of orthodontic treatment as well as the above problems.

Accordingly, the present applicant has somewhat overcome conventional problems such as extraction and pain, a longer treatment time, etc. by controlling the orthodontic device, which moves in the lateral direction in the prior art, in order to move in forward and backward directions, and therefore, has designed the present invention that can be expected to facilitate correction of artificially projecting teeth in a recessed set of teeth in addition to correction of bialveolar protrusion.

### SUMMARY

The present invention relates to a maxillary orthodontic appliance (referred to as “device”) capable of correcting maxillary molars and anterior teeth by moving molar teeth and anterior teeth in forward and backward directions, unlike a typical orthodontic device for widening the palatal portion, nasal septum and nasal cavity in left and right directions.

Especially, the maxillary orthodontic device includes: a body 10 attached to the bottom surface of the maxillary gums; a connection leg 20, one end of which is connected and extended from the body 10; a molar fixing member 30 connected to the other end of the connection leg 20 and fitted into a molar; and a ring member 40 connected to one side of the lower surface of the body 10, wherein die body 10 is divided into a first body 11 and a second body 12 such that a space is adjusted by spacing the first body 11 and the second body 12 apart from each other or bringing the same closer to each other in an incisor direction of the upper jaw and an airway direction.

### BRIEF DESCRIPTION OF DRAWINGS

FIG. 1 illustrates a wearing state and a configuration of the maxillary orthodontic device according to the present invention.

FIG. 2 illustrates a configuration of the body in the maxillary orthodontic device according to the present invention.

FIG. 3 illustrates a configuration of the maxillary orthodontic device according to another embodiment of the present invention.

### DETAILED DESCRIPTION

### Technical Problem

An object of the present invention is to provide a maxillary orthodontic device capable of correcting the entire maxillary teeth set by accurately moving molar teeth and anterior teeth in an incisor direction and an airway direction, unlike a typical orthodontic device for widening the palatal portion, nasal septum and nasal cavity in right and left directions, whereby pain and a time period of treatment are reduced while facilitating efficient correction.

### Technical Solution

In order to accomplish the above object, a maxillary orthodontic device according to the present invention may include: a body 10 attached to the bottom surface of the maxillary gum; a connection leg 20, one end of which is connected to and extends from the body 10; a molar fixing member 30 connected to the other end of the connection leg 20 and fitted into a molar; and a ring member 40 connected to one side of the lower surface of the body 10, wherein the body 10 is divided into a first body 11 and a second body 12 such that a space is adjusted by spacing the first body 11 and the second body 12 apart from each other or bringing the same closer to each other in an incisor direction of the upper jaw and an airway direction.

In this regard, the body 10 may include: the first body 11 and the second body 12; a moving groove 13 passing through from one direction to another direction at one side of the first body 11 and the second body 12; a support groove 14 passing through from one direction to another direction at the other side of the first body 11 and the second body 12; a moving shaft 15 inserted into the moving groove 13; and a support shaft 16 inserted into the support groove.

Further, the moving groove 13 may include a screw part 13a formed on an inner surface, while the moving shaft 15 may include: a rotary member 15a, which is configured at one side of the moving shaft 15 to rotate the moving shaft 15 and has a plurality of grooves formed on an outer surface thereof; and another screw part 15b formed on an outer surface of the moving shaft 15 and screw-threaded with the screw part 13a, whereby a space between the first body 11 and the second body 12 is adjusted by rotation of the rotary member 15a.

In addition, the ring member 40 may be selectively formed in only one of the incisor direction of the upper jaw and the airway direction at one side of the body 10.

### Advantageous Effects

According to the maxillary orthodontic device of the present invention, the entire maxillary teeth set can be corrected by accurately moving molar teeth and anterior teeth in an incisor direction and an airway direction, unlike a typical orthodontic device for widening the palatal portion, nasal septum and nasal cavity in right and left directions. Therefore, it is possible to avoid extraction required to create a space during teeth arrangement while, for a patient having many gaps in their teeth, firmly and selectively closing the gaps in desired positions, thereby reducing pain and a treatment period while facilitating efficient orthodontics.

### Best Mode

Terms and words used in the specification and claims should not be construed as being limited to general or dictionary meanings but be interpreted as meanings and concepts corresponding to technical aspects of the present invention, on the basis of the principle that the inventors can adequately define concepts of the terms in order to describe the invention in the best way.

Accordingly, in the present text, the configurations described in the embodiments and illustrated in the drawings are merely most preferable embodiments of the present invention and are not intended to represent the entire technical scope of the present invention. Therefore, it would be understood that there are various equivalents and modifications possibly replacing the most preferable embodiments mentioned above at the time of filing the present application.

Hereinafter, before description with reference to the accompanying drawings, it will be noted that undesirable or unnecessary matters in clarifying the essentials of the present invention, that is, known configurations obviously addable by those skilled in the art are not illustrated or concretely described.

The present invention provides a maxillary orthodontic device, capable of correcting maxillary molars and anterior teeth by moving molar teeth and anterior teeth in forward and backward directions, unlike a typical orthodontic device for widening the palatal portion, nasal septum and nasal cavity in right and left directions.

More particularly, with reference to the accompanying drawings, the following description will be given.

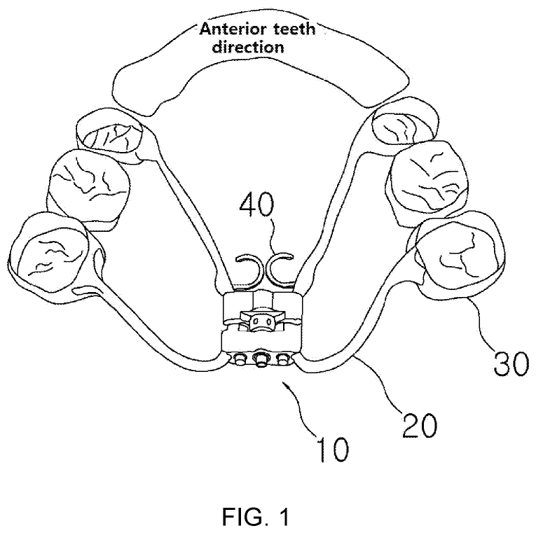

FIG. 1 illustrates a wearing state and a configuration of the maxillary orthodontic device according to the present invention, showing the upper jaw as viewed from the bottom. The maxillary orthodontic device of the present invention may include a body 10, a connection leg 20, a molar fixing member 30 and a ring member 40.

More particularly, the inventive deice may include the body 10 attached to the bottom surface of maxillary gum; the connection leg 20, one end of which is connected to and extends from the body 10; the molar fixing member 30 connected to the other end of the connection leg 20 and fitted into a molar; and the ring member 40 connected to one side of the body 10.

At this time, the above connection may be welding connection. In other words, in the case where the device is distributed as a first product, the body 10, the connection leg 20, the molar fixing member 30 and the ring member 40 may be desirably selected, thereby being manufactured as an alternative product.

Before description of specific configurations, operating relationship of the maxillary orthodontic device of the present invention will be described below with reference to FIG. 1 among the accompanying drawings.

After fabricating the connection leg 20 and the molar fixing member 30 to match a dental arch of a user, the body 10 is installed on the bottom surface of a maxillary palate (the roof of the mouth) by altering a shape of the connection leg 20.

Then, a fixing means such as screws is implanted inside the ring member 40 to fix the body 10.

Herein, the molar fixing member 30 is partially inserted into the molar (posterior tooth) while the remaining part is inserted in another tooth.

Further, the posterior teeth (molars) may receive a force in a moving direction of the body 10 by adjusting a distance from the body 10, in order to move and correct the maxillary molars in a rearward direction to the respiratory tract (“airway direction”).

Herein, referring to FIG. 1 among the accompanying drawings, the ring member 40 is placed in the incisor direction and fixed by the screws so that the body 10 may move in the airway direction at the other side of the incisor direction. Therefore, a space through which front teeth can move in the rearward direction is afforded, and effects of correcting the overall protruding maxillary dentition through rearward movement may be attained.

On the other hand, unlike FIG. 1, the ring member 40 may also be provided in the airway direction at one side of the body 10. In this case, the body 10 is fixed in the airway direction to thus move in the incisor direction, thereby performing orthodontics such as forward movement of maxillary teeth or forward protrusion of the maxillary bone.

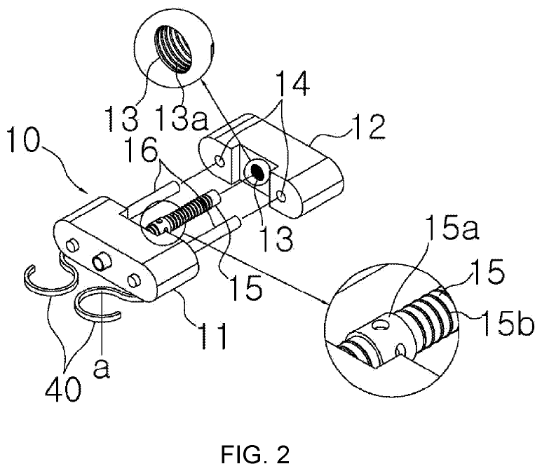

The body 10 is illustrated in FIG. 2 among the accompanying drawings.

FIG. 2 illustrates a configuration of the body in the maxillary orthodontic device according to the present invention.

The above body 10 is divided into a first body 11 and a second body 12. Each of the first body 11 and the second body 12 may have two or more grooves passing through from one direction to another direction. A moving shaft 15 and a support shaft 16 may be inserted into the two or more grooves to connect the first body 11 and the second body 12.

In the other words, one of the two or more grooves may be a moving groove 13 through which the moving shaft 15 is inserted while having a screw part 13a formed on an inner surface of the moving groove 13.

Further, another screw part 15b may be formed on an outer surface of the moving shaft 15. Therefore, the first body 11 and the second body 12 may be spaced apart from each other by a predetermined interval (0.25 mm) per turn of the moving shaft 15. Otherwise, when the inventive device is installed in a spaced state, the bodies may approach each other by rotating the moving shaft and the moving groove in the opposite direction.

A rotary member 15a may be provided at one end of the moving shaft 15 wherein the rotary member 15a is configured to rotate around the moving shaft 15 and includes a plurality of grooves formed along the outer surface of the rotary member 15a at a predetermined interval.

In this case, four (4) grooves are preferably formed. Further, the moving shaft 15 may rotate by fitting a rod into the grooves and rotating the rotary member 15a, thereby moving the first body 11 and the second body 12 by a predetermined interval.

Accordingly, when rotating the rotary member 15a through the four grooves, the first body 11 and the second body may be spaced apart from or approach each other by different distances, more particularly, around a total of 10 mm (1 cm), depending upon a diameter of the screw, an interval between screw threads, the number of screws, etc.

Further, the remaining one or more among the two or more grooves is a support groove 14 configured such that the support shaft 16 is inserted therein. The support shaft 16 may support the first body 11 and the second body 12 in order to facilitate movement thereof in a moving shaft direction when these bodies move to be spaced apart from or approach each other.

At this time, the first body 11 and the second body 12 may move in the incisor direction and the airway direction which is opposed to the incisor direction, as shown in FIG. 1 among the accompanying drawings.

In particular, in order to prevent the moving shaft from leaving the body parts when the body parts are spaced apart from or approach each other by rotation of the moving shaft, a moving shaft release preventing part 15c without screw threads may be formed at both ends of the moving shaft. In order to prevent release of the moving shaft due to a phenomenon of running idle at the moving shaft portion without screw threads when the moving shaft is excessively spaced, the moving shaft may have wider ends or a release preventing configuration of a pin structure inserted in the moving shaft.

The connection leg 20 is provided at one side of the body 10, and preferably, a predetermined number of connection legs is provided on each of the first body 11 and the second body 12.

The molar fixing member 30 is connected at one end of the connection leg 20, and more preferably, two connection legs 20 are fitted into a molar (posterior tooth) through the molar fixing member 30 while an additional number of connection legs may be further provided to be fitted into other teeth so as to disperse the force.

The connection leg 20 may be composed of a material to be changeable in shape by an external force such as manpower while being harmless to the human body (e.g., stainless steel, aluminum, etc.).

Referring to FIG. 2 among the accompanying drawings, the ring member 40 may be configured to be connected to a portion inside the body 10 or in the proximity of the body at the lower surface of the body, which is as close to the support shaft as possible.

Such a structure as described above has a configuration wherein the ring member is mounted on a fixed body part at the other side of a moving body part, configured to implant a screw nail therein in order to improve supporting force, and installed in the proximity of the body not exhibiting high rotational moment so as to securely offset the force generated due to reaction of the moving body part.

Further, the ring member is substantially provided in the most proximal portion to an extension line of the moving shaft in the center of the body, thereby ensuring firm supporting force on the extension line of the moving shaft located on the median line at which the strongest bone in the palatal portion exists.

As such, the ring member is set in more than 180° closed circular form, thereby having a shape that can effectively resist vertical and horizontal release force caused by reaction of the moving body part.

Further, since the ring member 40 is configured in an annular shape opened at one side and, even when replacing the body, the body is replaceable without removal of screws inserted in the gums.

According to the conventional orthodontic device, the body moves in the molar (posterior tooth) direction at both cheeks and the screws are inserted in both directions to secure the body, whereby the maxillary structure is not influenced by force to maintain the original shape. On the other hand, according to the present invention, the ring member 40 fixed by inserting screws to smoothly move the body 10 is provided only in one of an incisor direction and an airway direction. Moreover, due to resistance of the maxillary structure generated by receiving reaction force in the incisor direction and the airway direction while the moving body 100 moves several teeth, even when the first body 11 and the second body 12 are spaced apart from each other through the moving shaft 15 in order to make a space, the space may be narrowed again. On the contrary, even when decreasing the space, the above two bodies may sometimes be spaced apart from each other again.

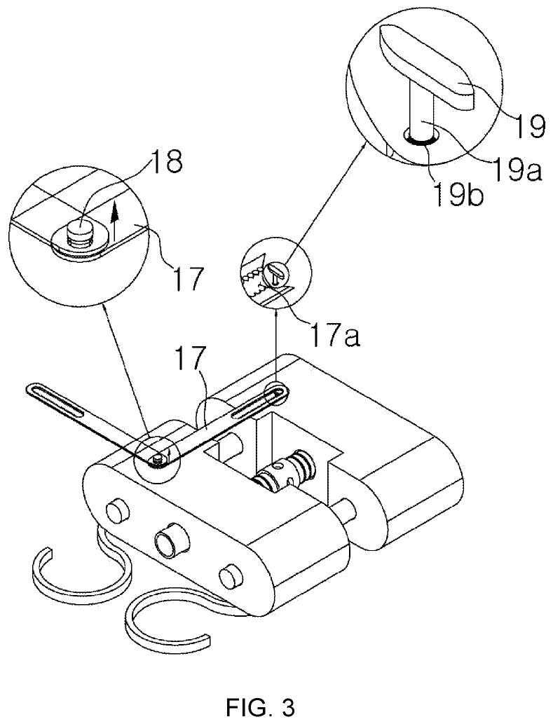

Under the above background, the present applicant has further proposed the following structure in another embodiment of the present invention. This refers to FIG. 3 among the accompanying drawings.

FIG. 3 illustrates a configuration of the maxillary orthodontic device according to another embodiment of the present invention.

Referring to FIG. 3 among the accompanying drawings, the present invention may further include a fixing bar 17 connected at one side of a body through a fixing pin 18 and a fixing member 19 provided at one side of the other body.

Herein, a hole (without a numeral in the figure) in which the fixing pin 18 of the fixing bar 17 is inserted may have a smaller size than a head of the fixing pin 18, while the fixing bar 17 is rotatable about the fixing pin 18 and may be configured to move upward/downward along the fixing pin 18.

An uneven part 17a is formed like a groove at one end of the fixing bar 17 and has a configuration wherein uneven patterns composed of alternate concave and convex faces in “\hat{ }\hat{ }\hat{ }\hat{ }” shape.

Further, the head of the fixing member 19 may be configured to correspond to the configuration of the uneven part 17a wherein a pillar is formed in a downward direction of the head.

The pillar of the fixing member 19 is fitted into a fixing hole 19b formed at one side of the body, wherein a torsion spring is inserted into and fixed to an outer surface of the pillar and fitted into the fixing hole 19b. Accordingly, the fixing member 19 may rotate in the fixing hole 19b by an external force such as manpower and, when the force is removed, rotate backward to return to the original state. Alternatively, the fixing member may also be configured to rotate only by the external force without application of the torsion spring.

Briefly, by fitting the head of the fixing member 19 in the uneven part 17a of the fixing bar 17 in the same direction as the uneven part 17a and then, adjusting the head of the fixing member 19 to be perpendicular to the uneven part 17a, the fixing bar 17 may be connected and fixed to the fixing member 19. Herein, the uneven part 17a has an uneven configuration composed of alternately concave and convex faces, thereby being properly fixed with different lengths.

Further, according to another embodiment, an interval between concave portions in the uneven part 17a may be 2.5 mm.

With regard to the above configuration, FIG. 3 among the accompanying drawings illustrates only a single configuration at one side, however, according to design conditions, multiple configurations may also be adopted on both sides or a single configuration may be provided in the middle portion.

Accordingly, since force transferred from the upper jaw to the body 10 is dispersed and received by the fixing bar 17 and the fixing member 19, it is predicted to completely prevent alteration in an adjusted space of the body 10.

The above description with reference to FIGS. 1 to 3 includes significant matters of the present invention only and, since a variety of designs is possible within the technical scope of the present invention, it is obviously appreciated that the present invention should not be limited to such configurations as shown in FIGS. 1 to 3.

What is claimed is:

1. A maxillary orthodontic device, comprising:
a body (10) attached to a bottom surface of maxillary gum;
a connection leg (20), one end of which is connected to and extends from the body (10);
a molar fixing member (30) connected to another end of the connection leg (20) and fitted into a molar; and
a ring member (40) connected to one side of a lower surface of the body (10),
wherein the body (10) is divided into a first body (11) and a second body (12) such that a space is adjusted by spacing the first body (11) and the second body (12) apart from each other or bringing the same closer to each other in an incisor direction of an upper jaw and an airway direction,
wherein the ring member (40) is configured in an annular shape opened at one side and does not need to remove a screw inserted in the gum when replacing the body (10), and
wherein the ring member (40) is selectively formed in only one of the incisor direction of the upper jaw and the airway direction at one side of the body (10).

2. The device according to claim 1, wherein the body (10) includes:
the first body (11) and the second body (12);
a moving groove (13) passing through from one direction to another direction at one side of the first body (11) and the second body (12);
a support groove (14) passing through from one direction to another direction at another side of the first body (11) and the second body (12);
a moving shaft (15) inserted into the moving groove (13); and
a support shaft (16) inserted into the support groove.

3. The device according to claim 2, wherein the moving groove (13) includes a screw part (13a) formed on an inner surface thereof, and the moving shaft (15) includes:
a rotary member 15a, which is configured at one side of the moving shaft (15) to rotate the moving shaft (15) and has a plurality of grooves formed on an outer surface thereof; and
another screw part (15b) formed on an outer surface of the moving shaft (15) and screw-threaded with the screw part (13a) so that a space between the first body (11) and the second body (12) is adjusted by rotation of the rotary member 15a,
wherein the moving shaft (15) further includes a moving shaft release preventing part (15c) formed at an end of the moving shaft (15).
